(19) United States
(12) Patent Application Publication
(10) Pub. No.: US 2005/0160711 A1
(43) Pub. Date: Jul. 28, 2005

(54) Air filtration media

(76) Inventor: Alain Yang, Bryn Mawr, PA (US)

Correspondence Address: DUANE MORRIS, LLP;IP DEPARTMENT, ONE LIBERTY PLACE, PHILADELPHIA, PA, 19103-7396, US

(21) Appl. No.: 10/766,052

(22) Filed: Jan. 28, 2004

(51) Int. Cl. B01D 46/00

(52) U.S. Cl. 55/524; 55/527; 55/528

(57) ABSTRACT

A glass fiber composite air filtration media is fabricated from glass fibers and plastic-containing boding fibers. The glass fibers may be virgin rotary fibers, loose-fill blowing wool insulation, bindered glass fibers such as batting insulation, or scrap rotary fibers.

### FIELD OF THE INVENTION

The present invention relates to air filtration media and, in particular, to glass fiber composite air filtration media comprising a mat of uniformly blended glass fibers and plastic-containing bonding fibers in which the plastic-containing bonding fibers act as a binder as well as a reinforcement for the composite matrix which is especially suited for use in industrial air filtration applications.

### BACKGROUND OF THE INVENTION

Industrial air filters reduce the level of particulates in the air to a cleanliness standard required for a given application. It extends from the simple task of preventing lint and other debris from plugging heating and air conditioning coils to removing particles as small as 0.1 micron in cleanroom environment.

Plastic fiber filtration media currently used in many industrial air filtration applications, made of plastic fibers such as polyester fibers and bi-component polymer fibers, offer good fiber distribution in the air filtration media and the ability to thermally bond the fiber matrix without the use of phenol-formaldehyde resin binders. But the filtration performance of the plastic fiber filtration media are not suitable for very demanding requirements.

Conventional glass fiber air filtration media using glass fibers of less than 5 micron diameter provide higher filtration performance compared to the plastic fiber filtration media because of the fineness of the glass fibers. However, the conventional glass fiber air filtration media do not have uniform fiber distribution which prevents achieving even higher filtration performance possible with the fine glass fibers.

The conventional glass fiber air filtration media are generally fabricated using the centrifugal blast attenuation process and/or flame attenuated process, generally known in the art. Details of various forms of these processes may be found, for example, in U.S. Pat. Nos. RE 24,708; 2,984,864; 2,991,507; 3,084,381; 3,084,525; 4,759,974; and 5,743,932, which are hererby incorporated herein by reference. In the centrifugal blast attenuation process, glass fibers spun from molten glass using a centrifuge spinner are sprayed with a resin binder and collected and formed into a batt. The batt is generally collected on a conveyer and transported directly into a curing oven and cured into a cured sheet having a desired thickness for the final product, in this case, air filtration media. This process produces cured sheets having adequate but uneven fiber distribution. Thus the cured sheets have areas of clumped fibers and other areas where the fibers density is low.

Thus, there is a need for improved fiber glass air filtration media that has even fiber distribution and high filtration efficiency.

### SUMMARY OF THE INVENTION

According to an aspect of the present invention, a glass fiber air filtration media is disclosed. The glass fiber air filtration media comprises a glass fiber composite mat formed from a blend of glass fibers and plastic-containing bonding fibers uniformly blended together with the glass fibers and bonding at least a portion of the glass fibers together by forming bonds at points of intersection between the glass fibers and the plastic-containing bonding fibers.

Preferably, the glass fiber component of the air filtration media may comprise virgin rotary glass fibers, textile fibers, or unbindered loose-fill type glass fibers. In another embodiment of the present invention, the glass fiber component may be batting insulation, or scrap rotary fibers.

In one embodiment of the present invention, the polymeric bonding fibers may be bi-component polymer fibers, mono-component polymer fibers, or both. Plastic coated mineral fibers, such as thermoplastic-coated glass fibers, may also be used.

According to another aspect of the present invention, a method of making glass fiber air filtration media is also disclosed. The method comprises the steps of blending glass fibers and plastic-containing bonding fibers into a fiber blend. Next, the fiber blend is formed into a sheet of uncured mat having a first and second major sides and a non-woven scrim facing layer is applied to at least one of the first and the second major sides. The whole configuration is then cured at an elevated temperature to form the glass fiber composite air filtration media.

The glass fiber air filtration media of the present invention is well suited for industrial air filter formats such as, for example, bag filters, box filters, and panel filters.

### BRIEF DESCRIPTION OF THE DRAWINGS

FIG. 1 is a cross-sectional view of an exemplary embodiment of a air filtration media according to an aspect of the present invention;

FIG. 2 is a schematic illustration of an apparatus for forming the air filtration media of the present invention;

FIG. 3a-3c are detailed schematic illustrations of the bale openers and the fibers pneumatic blending system of the apparatus of FIG. 2;

FIG. 4 is a detailed schematic illustration of another section of the apparatus of FIG. 2;

FIG. 5 is a flow chart diagram of a process for forming the exemplary glass fiber air filtration media of FIG. 1;

FIG. 6 is a plot comparing the air filtration performance of a sample of an air filtration media fabricated according to an embodiment of the present invention in to the performance range of conventional fiber glass air filtration media;

FIG. 7 is an illustration of the air filtration media of the present invention cut to size for installation into an air filter service frame;

FIG. 8 is an illustration of a bag filter fabricated from the air filtration media of the present invention;

FIG. 9 is an illustration of a cube filter fabricated from the air filtration media of the present invention;

FIG. 10 is an illustration of a pocket filter fabricated from the air filtration media of the present invention; and

FIG. 11 is an illustration of a panel filter fabricated from the air filtration media of the present invention.

### DETAILED DESCRIPTION

According to an aspect of the present invention, glass fiber air filtration media and a method of fabricating the air filtration media is disclosed. The air filtration media is formed by blending glass fibers and plastic-containing bonding fibers into an uncured mat and curing the uncured mat in an elevated temperature to form a cured mat of the air filtration media. The plastic-containing bonding fibers function as the binder, alone, or in combination with other thermoplastic binders, liquid or powdered resin binder materials, such as phenol-formaldehyde resins. The plastic-containing bonding fibers are uniformly blended together with the glass fibers in the mat and the plastic-containing bonding fibers bond at least a portion of the glass fibers together by forming bonds at points of intersection between the glass fibers and the plastic-containing bonding fibers. In other words, the plastic-containing bonding fibers bonds to the glass fibers at the points of intersection and form a three dimensional matrix of uniformly blended glass fibers and plastic-containing bonding fibers so that air can pass through the matrix.

Because of the small diameter of rotary glass fibers (3 microns or less for virgin fibers and 5 microns or less for scrap fibers), the resulting filtration media has high specific surface (i.e. fiber surface area per weight) and is particularly suited for residential and industrial applications. Some examples of industrial air filtration applications include, for example, building heating and air conditioning systems; cleanroom air filtration system; spray painting rooms, etc. Industrial air filters used in these applications can come in many configurations, these include: bag filters, box filters, cube filters, pocket filters, panel filters, ring panels, slip-ons, etc.

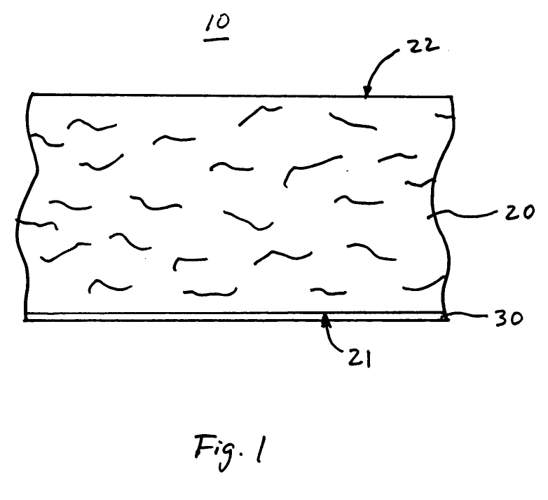

FIG. 1 is a cross-sectional view of an exemplary glass fiber air filtration media 10 comprising a cured glass fiber mat 20 having a first major side 21, a second major side 22 and a non-woven facing layer bonded to the first major side 21. The non-woven facing layer may be made of polyethylene polymer. The cured glass fiber mat 20 comprises glass fibers and plastic-containing bonding fibers where the plastic-containing bonding fibers are about 5 to 50 wt. % and preferably about 10 to 30 wt. % of the finished product. The cured glass fiber mat 20 has a density of about 8.0 to 26.0 kg/m³ (0.5 to 1.6 pounds per cubic feet (pcf)) and preferably about 9.6 to 16 kg/m³ (0.6 to 1.0 pcf). The gram weight of the air filtration media 10 is in the range of about 60 to 250 gm/m². The thickness of the air filtration media 10 is about 4 to 10 mm (0.16 to 0.4 inches), preferably about 4 to 8 mm (0.16 to 0.31 inches), and more preferably about 6 to 8 mm (0.23 to 0.31 inches).

The glass fibers used to form the air filtration media according to an embodiment of the present invention may comprise virgin rotary glass fibers, textile fibers, unbindered loose-fill glass fibers, or bindered glass fibers such as batting insulation. The glass fibers have an average diameter of about 6 microns or less and more preferably about 3 microns or less for virgin fibers and 5 microns or less for scrap fibers. The average length of the glass fibers is about 3 inches or less and more preferably about 2 inches or less.

In a preferred embodiment of the present invention, virgin rotary glass fibers taken directly from the centrifugal blast spinners may be used for the air filtration media of the present invention without any additional processing. In another embodiment of the present invention, loose-fill type glass fibers may be used. Loose-fill glass fibers are commercially available, for example, in the form of glass fiber insulation commonly referred to as “blowing wool” insulation. Examples of suitable glass fiber materials for use according to the present invention include INSULSAFE IV® blowing insulations made by CertainTeed Corporation of Valley Forge, Pa. In these embodiments, the resulting air filtration media product will be substantially formaldehyde-free because the raw material components, the virgin glass fibers and the plastic-containing bonding fibers are formaldehyde-free. Formaldehyde-free air filtration media products may be desired by the manufacturing industry as well as the consumer population because of the possible health benefits of formaldehyde-free products. The manufacturing process for such air filtration media products are also environmentally friendlier than the processes involving the use of the conventional phenol-formaldehyde resin binders because there are no concerns of air-borne formaldehyde residue to be concerned with. Furthermore, the manufacturing process for such air filtration media products benefit from the fact that the exhaust air from the curing ovens, for example, need not be specially treated to remove any formaldehyde.

Bindered glass fiber insulation can include a binder substance such as cured phenol-formaldehyde resin binder or the like. Scrap rotary fibers or scrap batting insulation may also be directly used for the glass fiber component of the air filtration media of the present invention. It should be noted, however, that when scrap fibers or bindered fibers are used, the finished product may not be formaldehyde-free because, often, scrap fibers contain formaldehyde containing binder.

The plastic-containing bonding fibers used as the binder in the air filtration media of the present invention may be bi-component polymer fibers, mono-component polymer fibers, plastic-coated mineral fibers, such as, thermoplastic-coated glass fibers, or a combination thereof. The bi-component polymer fibers are commonly classified by their fiber cross-sectional structure as side-by-side, sheath-core, islands-in-the sea and segmented-pie cross-section types.

In a preferred embodiment of the present invention, the sheath-core type bi-component polymer fibers are used. The bi-component polymer fibers have a core material covered in a second sheath material that has a lower melting temperature than the core material. Typical core materials used in this type of bi-component polymer fibers are thermoplastic polymers such as polyethylene, polypropylene, polyester, polyethylene teraphthalate, polybutylene teraphthalate, polycarbonate, polyamide, polyvinyl chloride, polyethersulfone, polyphenylene sulfide, polyimide, acrylic, fluorocarbon, polyurethane, or other thermoplastic polymers. The sheath may be made from a different thermoplastic polymer or the same thermoplastic polymer as the core but made of different formulation so that the sheath has a lower melting point than the core. Typically, the melting point of the sheath is between 110° and 180° Centigrade. The melting point of the core material is typically about 260° Centigrade. Thus, during the curing of the air filtration material of the present invention, the sheath material melts to form bonds at the points of intersection between the glass fibers and the plastic-containing bonding fibers. The two components of the bi-component polymeric fibers may have a sheath/core configuration as described or may also have a side-by-side configuration.

The bi-component polymer fibers used in the air filtration media of the present invention have an average fiber diameter less than about 20 μm and preferably about 16 μm. The bi-component polymer fibers have average length between about 10 to 127 mm (0.4 to 5.0 inches) and preferably about 102 mm (4 inches) or less.

In another embodiment of the present invention, mono-component polymeric fibers may be used as the binder rather than the bi-component polymeric fibers. The mono-component polymeric fibers used for this purpose may be made from the same thermoplastic polymers as the bi-component polymeric fibers. The melting point of various mono-component polymeric fibers will vary and one may choose a particular mono-component polymeric fiber to meet the desired curing temperature needs. Generally, the mono-component polymeric fibers will completely or almost completely melt during the curing process step and bind the glass fibers by forming bonds at the points of intersection between the glass fibers and the plastic-containing bonding fibers. The materials disclosed above in connection with the bi-component fibers can also be used in making mono-component fibers. Additionally, both mono-component and bi-component fibers can be used together, using the same or in combination with other thermoplastic binders or thermosetting resins.

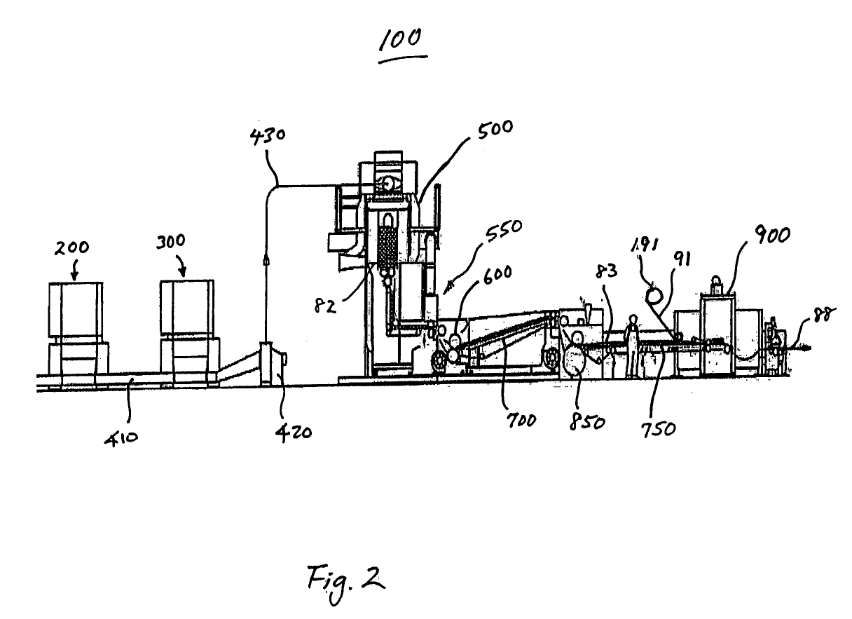

The air filtration media of the present invention is produced using an air laid process. In a preferred method of forming the air filtration media of the present invention, an air laid non-woven process equipment available from DOA (Dr. Otto Angleitner G. m. b. H. & Co. KG, A-4600 Wels, Daffingerstasse 10, Austria), equipment 100 illustrated in FIGS. 2-5, may be used. In this process every fiber component is finely and individually opened and separated, weighed, and then blended at a desired ratio in a collection of fibers through a pneumatic transportation system to a fiber condenser. In this example, a glass fiber mat for air filtration media of the present invention is formed by blending scrap rotary, textile, or virgin glass fibers such as loose fill glass fibers with bi-component polymer fibers as the binder. As illustrated in FIG. 2, the apparatus 100 includes bale openers 200 and 300, one for each type of fiber. The glass fibers are opened by the bale opener 200 and the bi-component polymer fibers are opened by the bale opener 300.

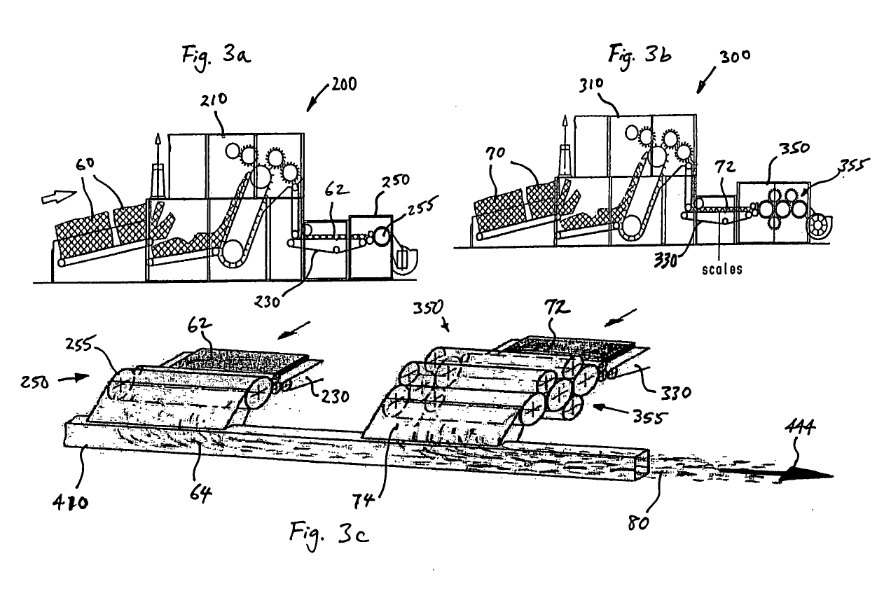

FIG. 3a is a detailed illustration of the bale opener 200. The glass fibers are provided in bulk form as bales 60. The bales 60 are fed into the bale opener which generally comprise a coarse opener 210 and a fine opener 250. The glass fibers are first opened by the coarse opener 210 and weighed by an opener conveyor scale 230. The opener conveyor scale 230 monitors the amount of opened glass fibers being supplied to the process by continuously weighing the supply of the opened glass fibers 62 as they are being conveyed. Next, the opened glass fibers are finely opened by the fine opener's picker 255. The opening process fluffs up the fibers to decouple the clustered fibrous masses in the bales and enhances fiber-to-fiber separation.

FIG. 3b is a detailed illustration of the bale opener 300. The bi-component polymer fibers as bales 70. The bales 70 are fed into the bale opener 300. The polymer fibers are first opened by a coarse opener 310 then weighed by an opener conveyor scale 330. The opener conveyor scale 330 monitors the amount of the opened polymer bonding fibers being supplied to the process by continuously weighing the supply of the opened polymer fibers 72. Next, the coarsely opened polymer fibers are finely opened by the fine opener 350 and its pickers 355. For illustrative purpose, the fine opener 350 is shown with multiple pickers 355. The actual number and configuration of the pickers would depending on the desired degree of separation of the opened fibers into individual fibers. The bale openers 200 and 300, including the components described above, may be provided by, for example, DOA's Bale Opener model 920/920TS.

Illustrated in FIG. 2 is a pneumatic transport system for transporting the opened fibers from the bale openers 200 and 300 to the down stream processing stations of the apparatus 100. The pneumatic transport system comprises a first transport conduit 410 in which the opened fibers are blended; an air blower 420; and a second transport conduit 430 for transporting the blended fibers up to the fiber condenser 500.

FIG. 3c illustrates opened glass fibers 64 and opened bi-component polymer fibers 74 being discharged into the first transport conduit 410 from their respective fine openers 250 and 350. The airflow in the first transport conduit 410 is represented by the arrow 444. The opened fibers 64 and 74 enters the air stream and are blended together into blended fibers 80. The ratio of the glass fibers and the bi-component polymer fibers are maintained and controlled at a desired level by controlling the amount of the fibers being opened and discharged by the bale openers using the weight information from the opener conveyor scales 230 and 330. As mentioned above, the conveyor scales 230, 330 continuously weigh the opened fiber supply for this purpose. In this example, the fibers are blended in a given ratio to yield the final air filtration precursor mat containing about 5 to 50 wt. %, and preferably about 10 to 30 wt. % of the polymer bonding fibers.

Although one opener per fiber component is illustrated in this exemplary process, the actual number of bale openers utilized in a given process may vary depending on the particular need. For example, one or more bale openers may be employed for each fiber component.

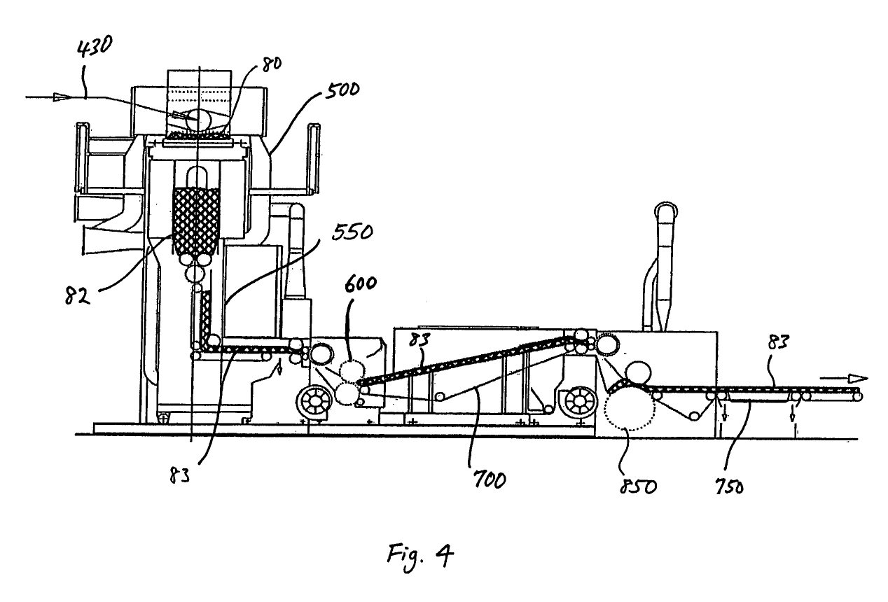

The blended fibers 80 are transported by the air stream in the pneumatic transport system via the second transport conduit 430 to a fiber condenser 500. Referring to FIG. 4, the fiber condenser 500 condenses the blended fibers 80 into less airy fiber blend 82. The condensing process separates air from the blend without disrupting the uniformity (or homogeneity) of the blended fibers. The fiber blend 82 is then formed into a continuous sheet of uncured mat 83 by the column feeder 550. At this point the uncured mat 83 may be optionally processed through a sieve drum sheet former 600 to adjust the openness of the fibers in the uncured mat 83. The uncured mat 83 is then transported by another conveyor scale 700 during which the uncured mat 83 is continuously weighed to ensure that the flow rate of the blended fibers through the fiber condenser 500 and the sheet former 600 is at a desired rate. The conveyor scale 700 is in communication with the first set of conveyor scales 230 and 330 in the bale openers. This feed back set up is used to further control the bale openers 200, 300 and that they are operating at appropriate speed to meet the demand of the subsequent processing steps. This feed back set up is used to control and adjust the feed rate of the opened fibers and the line speed of the conveyor scale 700 which are the primary variables that determine the gram weight of the uncured mat 83. The air laid non-woven process equipment 100 may be provided with an appropriate control system (not shown), such as a computer, that manages the operation of the equipment including the above-mentioned feed back loop function.

Before curing the uncured mat 83, a second sieve drum sheet former 850 is used to further adjust the fibers' openness at the desired gram weight which is very often different from the gram weight before the second sheet former. A conveyor 750 then transports the uncured mat 83 to a curing oven 900 (FIG. 2). For example, the condenser 500, column feeder 550, sieve drum sheet former 600, conveyor scale 700, and the second sieve drum sheet former 850 may be provided using DOA's Aerodynamic Sheet Forming Machine model number 1048.

In one embodiment of the present invention, a continuous web of polyethylene non-woven scrim facing 91 may be dispensed from a roll 191 and is applied to one of the two major sides of the uncured mat 83 before the uncured mat 83 enters the curing oven 900. In the exemplary process illustrated in FIG. 2, the non-woven scrim facing 91 is applied to the major side that is the top side of the uncured mat 83 as it enters the curing oven 900, but depending on the particular need and preference in laying out the fabrication process, the non-woven facing 91 may be applied to the bottom side of the uncured mat 83. The non-woven scrim faced side of the air filtration media is usually used as the air leaving side of the air filter formed from the filtration media.

After the non-woven layer 91 is applied, the uncured mat 83 is then fed into a curing oven 900 to cure the polymer bonding fibers. The curing oven 900 is a belt-furnace type. The curing temperature is generally set at a temperature that is higher than the curing temperature of the binder material. In this example, the curing oven 900 is set at a temperature higher than the melting point of the sheath material of the bi-component polymeric fibers but lower than the melting point of the core material of the bi-component polymeric fibers. In this example, the bi-component polymer fibers used is Celbond type 254 available from KoSa of Salisbury, N.C., whose sheath has a melting point of 110 ° C. And the curing oven temperature is preferably set to be somewhat above the melting point of the sheath material at about 145° C. The sheath component will melt and bond the glass fibers and the remaining core of the bi-component polymeric fibers together into a cured mat 88 which is the air filtration media precursor. The polymer bonding fibers are in sufficient quantity in the uncured mat 83 to bond the non-woven layer 91 to the mat. The core component of the bi-component polymeric fibers in the cured mat 88 provide reinforcement to the mat. The desired thickness of the final product, which determines the density of the final product, is fixed in the curing oven. The density of the product may be adjusted by adjusting the thickness of the uncured mat 83 which is initially formed and the degree to which this mat is compressed during subsequent forming processes. Product densities in the range of from 8.0 to 26.0 kg/m³ are possible.

In another embodiment of the present invention, the curing oven 900 may be set to be at about or higher than the melting point of the core component of the bi-component polymeric fiber. This will cause the bi-component fibers to completely or almost completely melt and serve generally as a binder without necessarily providing reinforcing fibers. Because of the high fluidity of the molten polymer fibers, the glass fiber mat will be better covered and bounded. Thus, less polymer bonding fibers may be used.

After curing, a series of finishing operations transform the cured mat 88 into air filtration media. The cured mat 88 exiting the curing oven 900 is cooled in a cooling section (not shown) then the edges of the mat is cut to desired width. The continuous mat is then cut to desired size and packaged for storage or shipping. The mat of air filtration media may be formed into rolls also.

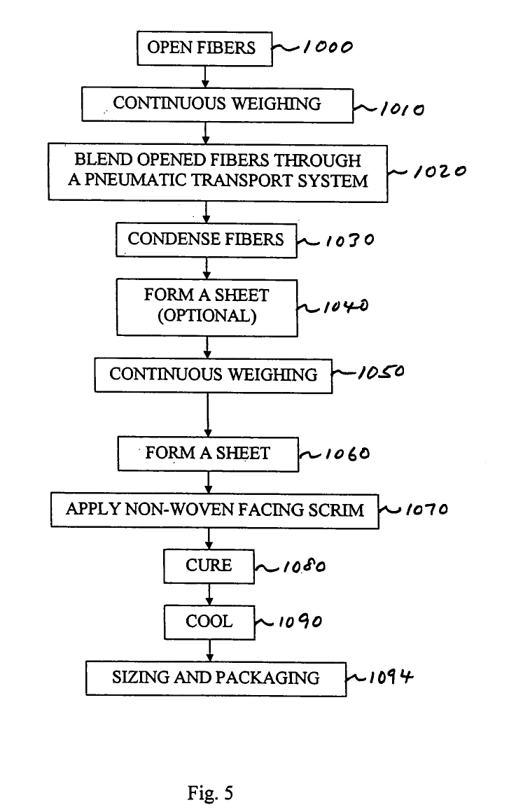

FIG. 5 is a flow chart diagram of the exemplary process.

At step 1000, the bales of the glass fibers and the bi-component polymer fibers are opened.

At step 1010, the opened fibers are weighed continuously by one or more conveyor scales to control the amount of each fibers being supplied to the process ensuring that proper ratio of fiber(s) are blended.

At step 1020, the opened fibers are blended and transported to a fiber condenser by a pneumatic transport system which blends and transports the opened fiber(s) in an air stream through a conduit.

At step 1030, the opened fibers are condensed into more compact fiber blend and formed into a continuously feeding sheet of uncured mat by a column feeder.

At an optional step 1040, a sieve drum sheet former may be used to adjust the openness of the fiber blend in the uncured mat.

At step 1050, the uncured mat is continuously weighed by a conveyor scale to ensure that the flow rate of the blended fibers through the fiber condenser and the sheet former is at a desired rate. The information from this conveyor scale is fed back to the first set of conveyor scale(s) associated with the bale openers to control the bale opener(s) operation. The conveyor scales ensure that a proper supply and demand relationship is maintained between the bale opener(s) and the fiber condenser and sheet former.

At step 1060, a second sieve drum sheet former adjusts the openness of the fibers and the final gram weight of the mat to a desired level.

At step 1070, a polyethylene non-woven scrim facing is applied to one of the two major sides of the uncured mat before the curing step. The non-woven scrim faced side of the mat will be the air leaving side of the air filter made from the filtration media.

At step 1080, the uncured mat is cured through a belt-furnace type curing oven. The curing oven is set at a temperature higher than the curing temperature of the bi-component polymer fibers and the mat is fixed here to the desired thickness.

At step 1090, the cured mat is cooled.

At step 1094, the cured mat is cut to desired sizes and packaged for storage or shipping.

The color of the basic air filtration media precursor mat as produced from the above-described process is generally white with virgin glass fiber or INSULSAFE® loose fill glass fiber and yellow when scrap glass fiber is used. The white color may be easily customized by adding appropriate coloring agents, such as dyes or colored pigments.

The density of the mat thus formed that is optimal for use as air filtration media is in the range of about 8.0 to 26.0 kg/m³ (0.5 to 1.6 pcf), preferably about 9.6 to 16.0 kg/m³ (0.6 to 1.0 pcf). The thickness of the air filtration media may be in the range of about 4 to 10 mm (0.16 to 0.4 inches), preferably about 4 to 8 mm (0.16 to 0.31 inches), and more preferably about 6 to 8 mm (0.23 to 0.31 inches). The porosity of the air filtration media is in the range of about 98.6 to 99.8% and preferably 99.0 to 99.7%. Also, the process of forming the uncured mat 83 described herein produces very uniformly distributed fibers within the mat. The evenness of the fiber distribution in the air filtration media of the present invention is a substantial improvement over the fiber distribution found in the conventional fiber glass air filtration media. The uniformity of fiber distribution in a fiber mat can be measured by measuring the variation in the weight of several samples cut into same sizes. For conventional fiber glass air filtration media this variation is typically in the range of ±10% or more. For the air filtration media of the present invention, this variation is typically in the range of ±5% or less.

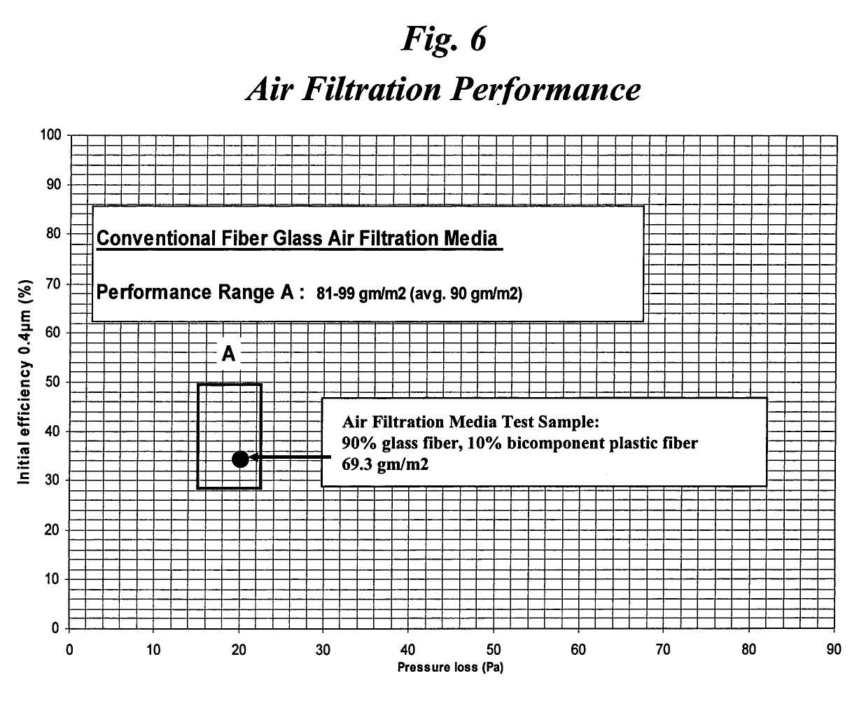

The inventor has fabricated a sample of air filtration media according to an embodiment of the present invention and verified that its air filtration performance is equal to that of conventional glass fiber air filtration media having substantially higher gram weight with the same kind of virgin glass fiber. In other words, the air filtration media fabricated according to an embodiment of the present invention can provide same filtration performance with less filter material. FIG. 6 is a plot of the air filtration performance of the sample of an air filtration media fabricated according to an embodiment of the present invention in comparison to the performance range of conventional fiber glass air filtration media. The test sample comprised of 90 wt. % virgin rotary fibers and 10 wt. % bi-component polymer fibers and had a gram weight of 69.3 gm/m². The virgin rotary glass fibers had average fiber diameter of about 1.5 microns. The initial filtration efficiency for 0.4 micron particulate size was about 34% with air pressure loss of 20 Pa. In FIG. 6, the area defined by A represents the typical initial efficiency range for a conventional fiber glass air filtration media having a gram weight in the range of 81-99 gm/m² made from glass fibers having average fiber diameter of about 1.5 microns. As illustrated, the performance of the sample air filtration media is well within the performance range for the conventional fiber glass air filtration media. Thus, the test sample air filtration media fabricated according to an embodiment of the present invention provides same filtration performance with less material.

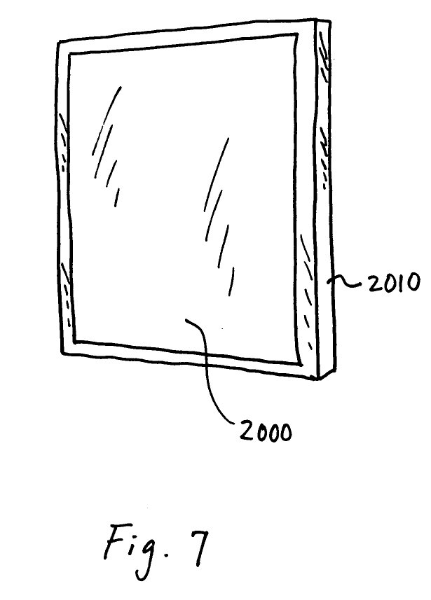

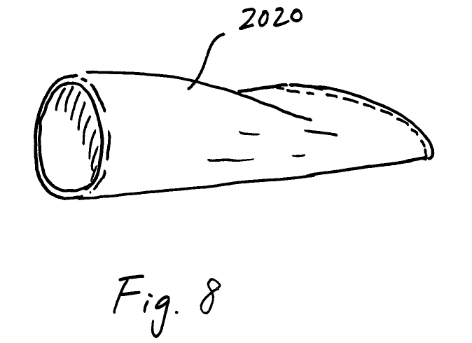

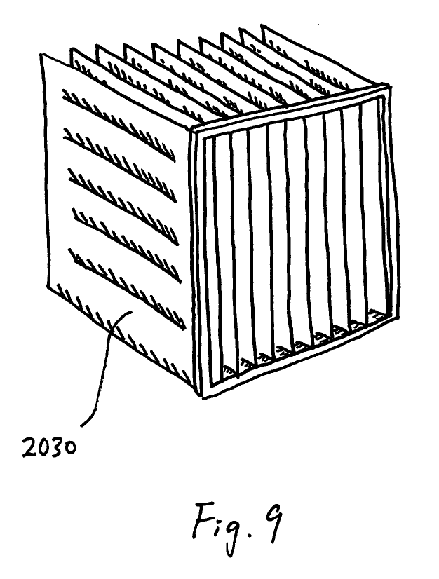

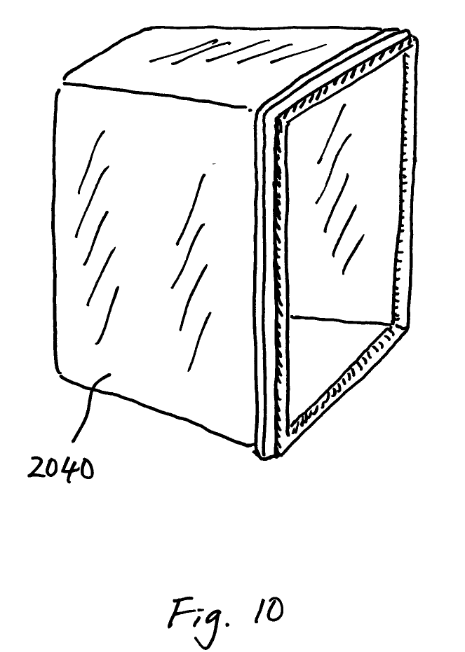

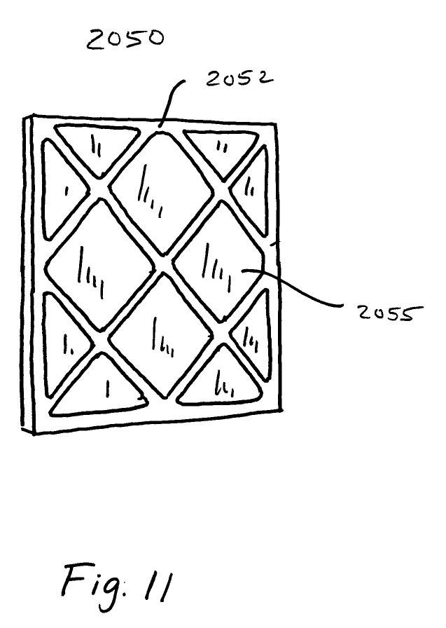

The air filtration media of the present invention described herein may be used to make a variety of air filtration products. In one example, the air filtration media 2000 may be provided to the end user in bulk form in rolls and cut to be fitted into air filter service frames 2010 in the field as illustrated in FIG. 7. FIG. 8 is an example of a bag filter 2020 fabricated from the air filtration media of the present invention. A bag filter is usually made of a fabric or a mat through which a gas stream is passed for the removal of particulate matter. FIG. 9 is an example of a cube filter 2030 made from the air filtration media of the present invention. FIG. 10 is an example of a pocket filter 2040 fabricated from the air filtration media of the present invention. Air filtration media 2050 is usually held inside a panel frame 2042 made of rigid material such as a card board. FIG. 11 is an example of a panel filter made from the air filtration media of the present invention.

Furthermore, because the air filtration media of the present invention uses plastic-containing bonding fibers rather than the conventional phenol-formaldehyde resin binders, in an embodiment of the present invention where the glass fiber component is virgin rotary glass fibers or unbindered loose fill fibers, the resulting air filtration media are substantially formaldehyde-free. Because of concerns of possible, and yet unproven, health risks associated with formaldehyde in filtration media due to air flow, formaldehyde-free products provide the consumers the additional option in selecting air filtration media. Elimination of the formaldehyde-containing resin binders also simplifies the manufacturing process because there is no need for air treatment equipment to remove formaldehyde from the curing oven's exhaust air.

While the air filtration media of the present invention is primarily intended for air filtration, the air filtration media can also be used to filter various types of gases and gaseous mixtures.

While the foregoing invention has been described with reference to the above embodiments, various modifications and changes can be made without departing from the spirit of the invention. Accordingly, all such modifications and changes are considered to be within the scope of the appended claims.

1. A glass fiber air filtration media comprising:
glass fibers; and
plastic-containing bonding fibers uniformly blended together with the glass fibers and bonding at least a portion of the glass fibers together by forming bonds at points of intersection between the glass fibers and the plastic-containing bonding fibers.

2. The glass fiber air filtration media of claim 1, wherein the air filtration media has a first major side and a second major side;
a thermoplastic non-woven facing layer bonded to one of the two major sides of the air filtration media.

3. The glass fiber air filtration media of claim 2, wherein the thermoplastic non-woven facing layer comprises a polypropylene polymer.

4. The glass fiber air filtration media of claim 1, wherein the glass fibers are rotary glass fibers.

5. The glass fiber air filtration media of claim 1, wherein the glass fibers are loose-fill glass fibers.

6. The glass fiber air filtration media of claim 1, wherein the glass fibers have an average fiber diameter not greater than about 5 microns.

7. The glass fiber air filtration media of claim 1, wherein the glass fibers have an average fiber diameter not greater than about 3 microns.

8. The glass fiber air filtration media of claim 1, wherein the glass fibers have an average length not greater than about 76 mm (3 inches).

9. The glass fiber air filtration media of claim 1, wherein the glass fibers have an average length not greater than about 51 mm (2 inches) in length.

10. The glass fiber air filtration media of claim 1, wherein the plastic-containing bonding fibers having an average fiber diameter not greater than about 20 microns.

11. The glass fiber air filtration media of claim 1, wherein the plastic-containing bonding fibers having an average fiber diameter of about 16 microns.

12. The glass fiber air filtration media of claim 1, wherein the plastic-containing bonding fibers having an average length between about 10 to 127 mm (0.4 to 5 inches).

13. The glass fiber air filtration media of claim 1, wherein the plastic-containing bonding fibers having an average length of not greater than about 102 mm (4 inches).

14. The glass fiber air filtration media of claim 1, wherein the plastic-containing bonding fibers are between about 5 to 50 wt. % of the air filtration media.

15. The glass fiber air filtration media of claim 1, wherein the plastic-containing bonding fibers are between about 10 to 30 wt. % of the air filtration media.

16. The glass fiber air filtration media of claim 1, wherein the variation in the gram weight of the air filtration media is ±5% or less.

17. The glass fiber air filtration media of claim 1, wherein the plastic-containing bonding fibers are bi-component thermoplastic polymer fibers.

18. The glass fiber air filtration media of claim 1, wherein the plastic-containing bonding fibers are mono-component thermoplastic polymer fibers.

19. The glass fiber air filtration media of claim 1, wherein the air filtration media is substantially formaldehyde-free.

20. The glass fiber air filtration media of claim 17, wherein the bi-component thermoplastic polymer fibers comprise:
a core material; and
a sheath material, the sheath material having a melting point temperature that is lower than the melting point temperature of the core material, wherein the sheath material forms the bonds at the points of intersection between the glass fibers and the plastic-containing bonding fibers.

21. The glass fiber air filtration media of claim 20, wherein the core material and the sheath material are both thermoplastic polymers

22. The glass fiber air filtration media of claim 20, wherein the core material is a mineral and the sheath material is a thermoplastic polymer.

23. The glass fiber air filtration media of claim 20, wherein the core material and the sheath material are same thermoplastic polymer but of different formulation.

24. An air filter fabricated from a glass fiber air filtration media, wherein the glass fiber air filtration media comprises:
glass fibers, and
plastic-containing bonding fibers uniformly blended together with the glass fibers and bonding at least a portion of the glass fibers together by forming bonds at points of intersection between the glass fibers and the plastic-containing bonding fibers.

25. The air filter of claim 24, wherein the air filter is a bag filter.

26. The air filter of claim 25, wherein the air filter is a cube filter.

27. The air filter of claim 24, wherein the air filter is a pocket filter.

28. The air filter of claim 24, wherein the air filter is a panel filter.

29. The air filter of claim 24, wherein the air filtration media has a first major side and a second major side;
a polyethylene non-woven facing layer bonded to one of the two major sides of the air filtration media.

30. The air filter of claim 24, wherein the glass fibers are rotary glass fibers.

31. The air filter of claim 24, wherein the glass fibers are loose-fill glass fibers.

32. The air filter of claim 24, wherein the glass fibers have an average fiber diameter not greater than about 5 microns.

33. The air filter of claim 24, wherein the glass fibers have an average fiber diameter not greater than about 3 microns.

34. The air filter of claim 24, wherein the glass fibers have an average length not greater than about 76 mm (3 inches).

35. The air filter of claim 24, wherein the glass fibers have an average length not greater than about 51 mm (2 inches) in length.

36. The air filter of claim 24, wherein the plastic-containing bonding fibers having an average fiber diameter not greater than about 20 microns.

37. The air filter of claim 24, wherein the plastic-containing bonding fibers having an average fiber diameter of about 16 um.

38. The air filter of claim 24, wherein the plastic-containing bonding fibers having an average length between about 10 to 127 mm (0.4 to 5 inches).

39. The air filter of claim 24, wherein the plastic-containing bonding fibers having an average length of not greater than about 102 mm (4 inches).

40. The air filter of claim 24, wherein the plastic-containing bonding fibers are between about 5 to 50 wt. % of the air filtration media.

41. The air filter of claim 24, wherein the plastic-containing bonding fibers are between about 10 to 30 wt. % of the air filtration media.

42. The air filter of claim 24, wherein the variation in the gram weight of the air filtration media is ±5% or less.

43. The air filter of claim 24, wherein the plastic-containing bonding fibers are bi-component thermoplastic polymer fibers.

44. The air filter of claim 24, wherein the plastic-containing bonding fibers are mono-component thermoplastic polymer fibers.

45. The air filter of claim 43, wherein the bi-component thermoplastic polymer fibers comprise:
a core material; and
a sheath material, the sheath material has a melting point temperature that is lower than the melting point temperature of the core material, wherein the sheath material forms the bonds at the points of intersection between the glass fibers and the plastic-containing bonding fibers.

46. The air filter of claim 45, wherein the core material and the sheath material are both thermoplastic polymers.

47. The air filter of claim 45, wherein the core material is a mineral and the sheath material is a thermoplastic polymer.

48. The air filter of claim 45, wherein the core material and the sheath material are same thermoplastic polymer but of different formulation.

49. The air filter of claim 45, wherein the air filter is substantially formaldehyde-free.

50. A method of making glass fiber air filtration media, comprising the steps of:
opening bulk glass fibers and bulk plastic-containing bonding fibers;
blending the opened glass fibers and the plastic-containing bonding fibers into a fiber blend;
condensing the blended fibers into less airy fiber blend using a fiber condenser;
forming the fiber blend into an uncured mat having a first and second major sides using a column feeder;
applying a non-woven scrim facing layer to at least one of the first and the second major sides; and
curing the uncured mat and the non-woven scrim facing layer into the glass fiber air filtration media.

51. The method of claim 50, wherein the glass fibers are virgin rotary glass fibers.

52. The method of claim 50, wherein the glass fibers are loose-fill glass fibers.

53. The method of claim 50, wherein the glass fibers are scrap rotary glass fibers.

54. The method of claim 50, wherein the glass fibers have an average fiber diameter not greater than about 5 microns.

55. The method of claim 50, wherein the glass fibers have an average fiber diameter not greater than about 3 microns.

56. The method of claim 50, wherein the glass fibers have an average length not greater than about 76 mm (3 inches).

57. The method of claim 50, wherein the glass fibers have an average length not greater than about 51 mm (2 inches) in length.

58. The method of claim 50, wherein the plastic-containing bonding fibers having an average fiber diameter not greater than about 20 microns.

59. The method of claim 50, wherein the plastic-containing bonding fibers having an average fiber diameter of about 16 microns.

60. The method of claim 50, wherein the plastic-containing bonding fibers having an average length between about 10 to 127 mm (0.4 to 5 inches).

61. The method of claim 50, wherein the plastic-containing bonding fibers having an average length of not greater than about 102 mm (4 inches).

62. The method of claim 50, wherein the plastic-containing bonding fibers are between about 5 to 50 wt. % of the air filtration media.

63. The method of claim 50, wherein the plastic-containing bonding fibers are between about 10 to 30 wt. % of the air filtration media.

64. The method of claim 50, wherein the variation in the gram weight of the air filtration media is ±5% or less.

65. The method of claim 50, wherein the plastic-containing bonding fibers are bi-component thermoplastic polymer fibers, the plastic-containing bonding fibers form bonds at points of intersection with the glass fibers during the curing step.

66. The method of claim 50, wherein the plastic-containing bonding fibers are mono-component thermoplastic polymer fibers, the plastic-containing bonding fibers form bonds at points of intersection with the glass fibers during the curing step.

67. The method of claim 65, wherein the bi-component thermoplastic polymer fibers comprise:
a core material; and
a sheath material, the sheath material has a melting point temperature that is lower than the melting point temperature of the core material, wherein the sheath material forms the bonds at the points of intersection between the glass fibers and the plastic-containing bonding fibers.

68. The method of claim 50, wherein the step of opening further comprising the step of weighing the opened fibers to monitor the feed rate of the opened fibers.

69. The method of claim 50, wherein the step of forming the fiber blend into the uncured mat further comprising continuously weighing the uncured mat to ensure that the flow rate of the blended fibers through the fiber condenser and the column feeder is at a desired rate.
